(19) United States
(12) Patent Application Publication
(10) Pub. No.: US 2026/0169724 A1
(43) Pub. Date: Jun. 18, 2026

(54) OVER-THE-AIR UPDATE DEVICE AND METHOD

(71) Applicants: HYUNDAI MOTOR COMPANY, Seoul (KR); KIA CORPORATION, Seoul (KR)

(72) Inventor: Dong Won Choi, Hwaseong-si (KR)

(73) Assignees: HYUNDAI MOTOR COMPANY, Seoul (KR); KIA CORPORATION, Seoul (KR)

(21) Appl. No.: 19/227,191

(22) Filed: Jun. 3, 2025

(30) Foreign Application Priority Data
Dec. 16, 2024 (KR) 10-2024-0187742

(51) Int. Cl. G06F 8/65; H04L 67/00

(52) U.S. Cl. CPC G06F 8/65; H04L 67/34

(57) ABSTRACT

An over-the-air (OTA) update device includes a display that displays an OTA update approval window and a processor that controls the display. The processor determines update target controllers based on controller information of a vehicle, controls the display to display the OTA update approval window in which options are provided for the determined update target controllers, and, when the update target controllers are selected via the options of the OTA update approval window, executes updates for the selected update target controllers.

### CROSS-REFERENCE TO RELATED APPLICATION

This application claims the benefit of and priority to Korean Patent Application No. 10-2024-0187742, filed in the Korean Intellectual Property Office on Dec. 16, 2024, the entire contents of which are incorporated herein by reference.

### TECHNICAL FIELD

The present disclosure relates to an update device and a method and, more particularly, to a technology that enables selective updates of OTA (Over-The-Air) update target controllers in a vehicle.

### BACKGROUND

In general, when OTA (Over-The-Air) update events are detected in a vehicle, OTA updates may be executed on controllers subjected to the events in the same cycle.

The controllers subjected to the events have limited functionality during the OTA update process and thus, a vehicle may only provide limited functionality to a user during the OTA update.

As a result, from the user's perspective, inconveniences such as the vehicle failing to start when the OTA update fails midway or the need for extended parking until the OTA update is completed have existed, when a driver executes OTA updates of a vehicle outside.

### SUMMARY

In view of the foregoing, there is a demand for the development of an OTA update device that provides a control environment where the user can directly select the OTA update target controllers of the vehicle, thereby enhancing user convenience.

The present disclosure has been made to solve the above-mentioned problems while advantages achieved by the prior art are maintained intact.

An aspect of the present disclosure provides an OTA update device and a method capable of improving user convenience and safety by allowing users to individually select update target controllers via an update approval window that provides options for each update target controller, and execute the update of a selected update target controller.

The technical problems to be solved by the present disclosure are not limited to the aforementioned problems, and any other technical problems not mentioned herein should be clearly understood from the following description by those having ordinary skill in the art to which the present disclosure pertains.

According to an aspect of the present disclosure, an over-the-air (OTA) update device includes a display that displays an OTA update approval window, and a processor that controls the display. The processor determines update target controllers based on controller information of a vehicle, controls the display to display the OTA update approval window in which options are provided for the determined update target controllers, and, when the determined update target controllers are selected via the options of the OTA update approval window, executes updates for the selected update target controllers (i.e., the update target controllers selected via the options displayed on the OTA update approval window).

In an embodiment, in determining the update target controllers, the processor may collect the controller information of the vehicle, transmit the collected controller information to an external server to obtain controller-specific OTA event information from the external server, and determine the update target controllers based on the obtained controller-specific OTA event information.

In an embodiment, in controlling the display, when the update target controllers are determined, the processor may download software corresponding to software releases of the determined update target controllers to a memory, and control the display to generate an OTA update approval window that includes options for the determined update target controllers and display the OTA update approval window.

In an embodiment, the processor may generate the OTA update approval window including controller names of the determined update target controllers, controller-specific options for selecting an update target controller, and an update type option for determining an update execution type.

In an embodiment, the processor may generate the OTA update approval window including information on update duration time for the determined update target controllers and information on unavailable vehicle functions due to update failure and available vehicle functions for the determined update target controllers.

In an embodiment, the processor may determine an update order of the selected update target controllers based on software release serial numbers of the selected update target controllers, and execute updates of the selected update target controllers according to or based on the determined update order.

In an embodiment, the processor may generate an update success report for the selected update target controllers when the update is completed and control the display to display the update success report.

According to an aspect of the present disclosure, an OTA update method of an OTA update device for a vehicle includes collecting controller information of the vehicle, determining update target controllers based on the controller information of the vehicle, displaying an OTA update approval window in which options are provided for the determined update target controllers, determining whether the determined update target controllers are selected via options of the OTA update approval window, and executing updates for the selected update target controllers when the determined update target controllers are selected.

### BRIEF DESCRIPTION OF THE DRAWINGS

The above and other objects, features and advantages of the present disclosure should be more apparent from the following detailed description taken in conjunction with the accompanying drawings, in which:

FIG. 1 is a block diagram illustrating a configuration of an over-the-air (OTA) update device according to an embodiment of the present disclosure;

FIG. 2 is a diagram for describing a process of selecting an update target controller of an OTA update device according to an embodiment of the present disclosure;

FIG. 3 is a diagram for describing OTA event information for each controller of an OTA update device according to an embodiment of the present disclosure;

FIG. 4 is a diagram for describing an OTA update approval window of an OTA update device according to an embodiment of the present disclosure;

FIGS. 5 and 6 are flowcharts for describing an OTA update method of an OTA update device according to an embodiment of the present disclosure; and

FIG. 7 illustrates a computing system for a vehicle according to an embodiment of the present disclosure.

### DETAILED DESCRIPTION

Hereinafter, some embodiments of the present disclosure are described in detail with reference to the drawings. In adding the reference numerals to the components of each drawing, it should be noted that the identical or equivalent component is designated by the identical numeral even when they are displayed on other drawings. Further, in describing an embodiment of the present disclosure, a detailed description of well-known features or functions has been ruled out in order not to unnecessarily obscure the gist of the present disclosure.

In describing the components of an embodiment according to the present disclosure, terms such as first, second, “A”, “B”, (a), (b), and the like may be used. These terms are merely intended to distinguish one component from another component, and the terms do not limit the nature, sequence or order of the constituent components. Unless otherwise defined, all terms used herein, including technical or scientific terms, have the same meanings as those generally understood by those having ordinary skill in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application. When a component, processor, controller, device, element, apparatus, or the like of the present disclosure is described as having a purpose or performing an operation, function, or the like, the component, processor, controller, device, element, apparatus, or the like should be considered herein as being “configured to” meet that purpose or to perform that operation or function. Each component, controller, device, element, apparatus, and the like may separately embody or be included with a processor and a memory, such as a non-transitory computer readable media, as part of the apparatus. The terms of a singular form may include plural forms unless otherwise specified.

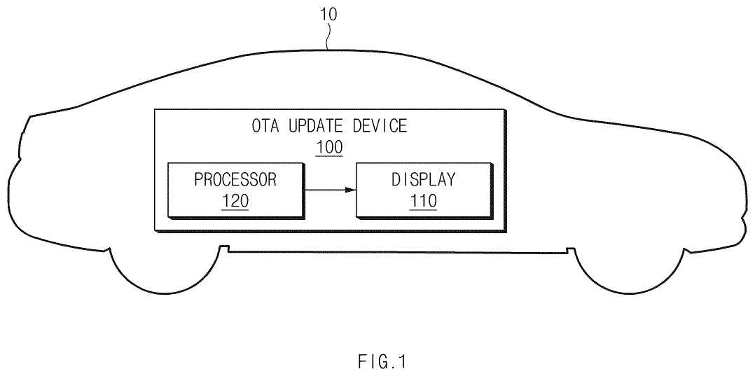

Hereinafter, embodiments of the present disclosure are described in detail with reference to FIGS. 1-7.

FIG. 1 is a block diagram illustrating a configuration of an OTA update device according to an embodiment of the present disclosure.

Referring to FIG. 1, an over-the-air (OTA) update device 100 of the present disclosure may include a display 110 that displays an OTA update approval window, and a processor 120 that controls the display 110.

The processor 120 may select or determine an update target controller (also referred to as a target controller) based on controller information of a vehicle 10, control the display 110 to display an OTA update approval window in which options are provided for each determined update target controller, and when update target controllers are selected via options of the OTA update approval window, execute updates for the selected update target controllers. Hereinafter, the update target controller selected or determined by the processor may be referred to as the “determined update target controllers” or “selected update target controllers.” The update target controller selected via the options of the OTA update approval window may be referred to as “selected update target controllers.” The meaning of “selected update target controllers” (i.e., meanings between the update target controllers selected or determined by the processor, and the update target controllers selected via the options of the OTA update approval window) may be determined based on the context of the description.

In addition, when selecting or determining the update target controller, the processor 120 may collect controller information of the vehicle 10, transmit the collected controller information to an external server to acquire OTA event information for each controller from the external server, and select or determine an update target controller based on the acquired OTA event information for each controller.

For example, the external server may include a DM (Device Management) server.

The OTA event information for each controller may include an OTA event list in which a software release name is matched with each controller.

For example, the OTA event list may include a controller name, a software release name, and a software release serial number, but this is only an example and is not limited thereto.

In addition, the OTA event list may further include vehicle model and year information, a project name, development stage information, destination information, and the like.

In addition, the OTA event list may include other distinctive identifiers, which are different from other software release serial numbers, in the software release serial numbers matched respectively with controllers that have dependencies on each other.

In another embodiment, when selecting or determining an update target controller, the processor 120 may collect controller information of the vehicle 10, determine whether an OTA event exists for each controller based on the collected controller information, and select or determine an update target controller based on a controller for which an OTA event exists.

When an OTA event for a controller of the vehicle 10 is received before the controller information of the vehicle 10 is collected, the processor 120 may generate an OTA event list in which a software release name is matched with each controller, and store the generated OTA event list in a memory.

For example, the OTA event list may include a controller name, a software release name, and a software release serial number.

In addition, the OTA event list may further include vehicle model and year information, a project name, development stage information, and destination information.

In addition, the OTA event list may include other distinctive identifiers, which are different from other software release serial numbers, in the software release serial numbers matched respectively with controllers that have dependencies on each other.

In addition, the processor 120 may determine whether an OTA event exists for each controller based on the collected controller information and the OTA event list stored in the memory when determining whether the OTA event exists for each controller.

In the case of controlling the display 110, when an update target controller is selected or determined, the processor 120 may download software corresponding to the software release of the selected update target controller to the memory, and control the display 110 to generate an OTA update approval window that includes options for the selected update target controller and display the OTA update approval window.

When downloading software, the processor 120 may download software corresponding to the software release of the selected update target controller into the ROM (Read Only Memory) of the memory.

When generating the OTA update approval window, the processor 120 may generate an OTA update approval window configured to display information including a controller name of an update target controller, controller-specific options for selecting a target controller to be updated, and an update type option for determining an update execution type.

When generating an OTA update approval window, the processor 120 may generate an OTA update approval window configured to display information including update duration time information for each target controller and information on unavailable vehicle functions due to update failure for each target controller and available vehicle functions.

For example, when generating an OTA update approval window, the processor 120 may arrange controller-specific options on one side of the controller names of update target controllers and arrange update duration time information on the other side of the controller names of the update target controllers.

In addition, when generating an OTA update approval window, the processor 120 may determine a priority based on update duration time information for each update target controller, and arrange a list of controller names of update target controllers according to the determined priority.

For example, the processor 120 may arrange the controller names of the update target controllers with relatively short update duration times in the upper part of the list (e.g., the part having a higher priority), and arrange the controller names of the update target controllers with relatively long update duration times in the lower part of the list (e.g., the part having a lower priority).

In addition, when generating an OTA update approval window, the processor 120 may determine the priority based on the information on unavailable vehicle functions due to update failure, and sort the list of controller names of the update target controllers according to the determined priority.

As an example, when the vehicle start function is not included in vehicle functions rendered unavailable due to an update failure, the processor 120 may arrange the controller names of the update target controllers in the upper part of the list and when the vehicle start function is included in the vehicle functions rendered unavailable due to an update failure, may arrange the controller names of the update target controllers in the lower part of the list.

In addition, when generating an OTA update approval window, the processor 120 may determine the priority based on information on the update duration time for each update target controller and the information on unavailable vehicle functions due to update failure, and sort the list of controller names of the update target controllers according to the determined priority.

For example, the processor 120 may arrange the controller names of the update target controllers in the upper part of the list when both a first condition that the update duration time is relatively short and a second condition that the vehicle start function is not included in the vehicle functions rendered unavailable due to an update failure are satisfied, arrange the controller names of the update target controllers in the middle part of the list when only one of the first and second conditions is satisfied, and arrange the controller names of the update target controllers in the lower part of the list when both the first and second conditions are not satisfied.

Then, when generating an OTA update approval window, the processor 120 may provide update type options including an “all update” option with an execution type that updates all update target controllers, a “selective update” option with an execution type that updates update target controllers based on user selection, and a “postpone” option for deferring the update of the update target controllers.

In addition, the processor 120 may further cause the display 110 to provide a “view details” option for providing detailed update information.

In addition, when generating an OTA update approval window, the processor 120 may generate an OTA update approval window configured to display information that includes guidance information on how to proceed with updating the update target controllers.

In addition, when the next driving cycle for update ends in the case of generating an OTA update approval window, the processor 120 may generate an OTA update approval window configured to display information including information about controllers that have completed the update and the controllers that have not completed the updates in the previous driving cycle.

In addition, when generating an OTA update approval window, the processor 120 may generate an OTA update approval window configured to display information including essential update information through recall and campaign and product improvement information having functional enhancement and functional addition.

Next, when executing the updates, the processor 120 may determine the update order of the selected update target controllers based on the software release serial numbers of selected update target controllers, and execute the updates of the selected update target controllers according to the determined order.

When a plurality of update target controllers have the same software release serial number in the case of determining the update order, the processor 120 may determine the update order according to a preset priority condition.

For example, the processor 120 may determine the update order based on the update duration time when the priority condition is based on the update duration time.

In other words, when the priority condition is based on the update duration time, the processor 120 may determine the update order of an update target controller with a short update duration time as a higher priority, and determine the update order of an update target controller with a long update duration time as a lower priority.

As another example, when the priority condition is based on an unavailable vehicle function due to an update failure, the processor 120 may determine the update order based on the unavailable vehicle function due to an update failure.

In other words, when the priority condition is based on vehicle functions rendered unavailable due to an update failure, the processor 120 may determine an update order such that the update target controllers whose unavailable vehicle functions due to update failure do not include the vehicle start function have higher priorities, and the update target controllers whose vehicle functions rendered unavailable due to an update failure include the vehicle start function have lower priories.

As another example, when the priority conditions are a first condition for the update duration time and a second condition for the unusable vehicle function due to the update failure, the processor 120 may determine the update order based on the first condition and the second condition.

In other words, the processor 120 may determine the update order such that update target controllers that satisfy both the first condition that the update requires a relatively short time, and the second condition that vehicle functions rendered unavailable due to an update failure do not include the vehicle start function, are assigned the highest priority, update target controllers that satisfy either the first condition or the second condition are assigned medium priority, and update target controllers that satisfy neither condition are assigned the lowest priority.

In addition, when the update is completed, the processor 120 may generate an update success report for the selected update target controller and control the display 110 to display the update success report.

In some cases, when the update is completed, the processor 120 may generate an update success report for the selected update target controller and transmit the update success report to an external server.

In this way, an embodiment of the present disclosure may improve user convenience and safety by individually selecting update target controllers through an OTA update approval window in which options are provided for each update target controller to execute updates for the selected update target controllers.

In addition, an embodiment of the present disclosure may improve user convenience by providing more detailed information on the updated content to a user and allowing the user to selectively apply a function capable of being updated according to the user's situation.

In addition, an embodiment the present disclosure may reduce emergency dispatches or customer claims by allowing the user to execute the updates in a safe place.

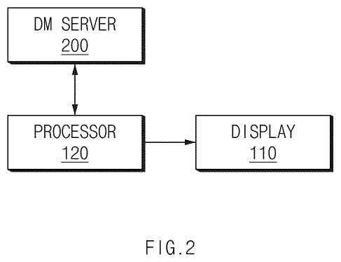

FIG. 2 is a diagram for describing a process of selecting an update target controller of an OTA update device according to an embodiment of the present disclosure.

Referring to FIG. 2, the processor 120 of the OTA update device according to an embodiment of the present disclosure may collect controller information of a vehicle and transmit the collected controller information to an external server, a DM (Device Management) server 200 via the vehicle's communication module.

In addition, the processor 120 may obtain OTA event information for each controller, which is identified to be a new release, from the DM server 200 via the vehicle's communication module, and select an update target controller based on the obtained OTA event information for each controller.

The OTA event information for each controller may include an OTA event list in which a software release name is matched with each controller.

Next, the processor 120 may generate an OTA update approval window in which options are provided for each update target controller based on the selected update target controller and provide the window to the display 110.

As another embodiment, the processor 120 of the OTA update device according to an embodiment of the present disclosure may directly determine whether an OTA event exists for each controller based on controller information collected by itself without using the DM server 200 and select the update target controller.

In other words, the processor 120 may collect the controller information of the vehicle, determine whether an OTA event exists for each controller based on the collected controller information, and select an update target controller based on a controller for which an OTA event exists.

When an OTA event for the controller of the vehicle is received before the controller information of the vehicle is collected, the processor 120 may generate an OTA event list in which software release names are matched respectively with each controller, and store the generated OTA event list in the memory.

In addition, the processor 120 may determine whether an OTA event exists for each controller based on the collected controller information and the OTA event list stored in the memory when determining whether the OTA event exists for each controller.

Subsequently, the processor 120 may generate an OTA update approval window providing selection options for each update target controller based on the selected update target controllers and display the OTA update approval window on the display 110.

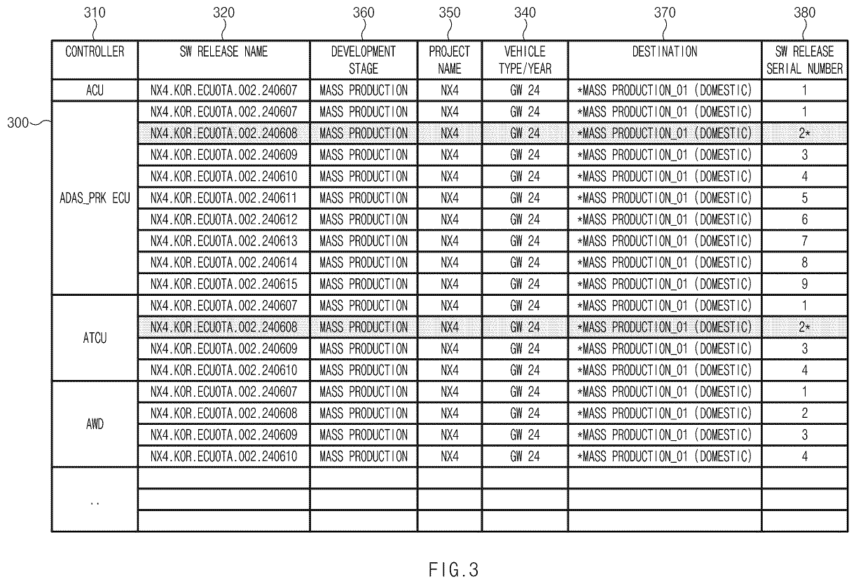

FIG. 3 is a diagram for describing OTA event information for each controller of an OTA update device according to an embodiment of the present disclosure.

Referring to FIG. 3, an embodiment of the present disclosure may select update target controllers based on OTA event information for each controller. The OTA event information may include an OTA event list 300 in which software release names 320 are matched respectively with controllers.

The OTA event list 300, as shown in FIG. 3, may include controller names 310, the software release names 320, and software release serial numbers 380. However, the OTA event list 300 is merely an example and is not limited thereto.

Additionally, the OTA event list 300 may further include vehicle type and model year information 340, project names 350, development stage information 360, and destination information 370.

Moreover, the OTA event list 300 may include other distinctive identifiers, which are different from other software release serial numbers, in the software release serial numbers 380 matched respectively with controllers that have dependencies on each other.

For example, in the OTA event list 300 of FIG. 3, the ADAS_PRK ECU controller and the ATCU controller may include a distinctive identifier, such as “2*”, which is different from other software release serial numbers, in their software release serial numbers 380 because they have dependencies on each other.

When there are dependencies between controllers, it is possible to use a different representation, such as 2* for the software release serial number, complete the update for software releases corresponding to the same serial number, and then execute the updates for the software release with the next higher serial number.

As shown in FIG. 3, it is possible to complete the update for software releases corresponding to the same serial number 2*, and then execute the updates sequentially for software releases corresponding to the next tier of serial numbers (3, 4, 5, . . . ).

As described above, an embodiment of the present disclosure may collect controller information of a vehicle and transmit the controller information to a Device Management (DM) server. The DM server may determine whether there are new releases for each controller unit and provide a response.

Alternatively, an embodiment of the present disclosure may directly determine whether there are new releases for each controller based on the collected controller information of the vehicle.

When an OTA event for a vehicle's controller is received, an embodiment of the present disclosure may generate an OTA event list in which software release names are matched respectively with controllers and store the OTA event list in the memory.

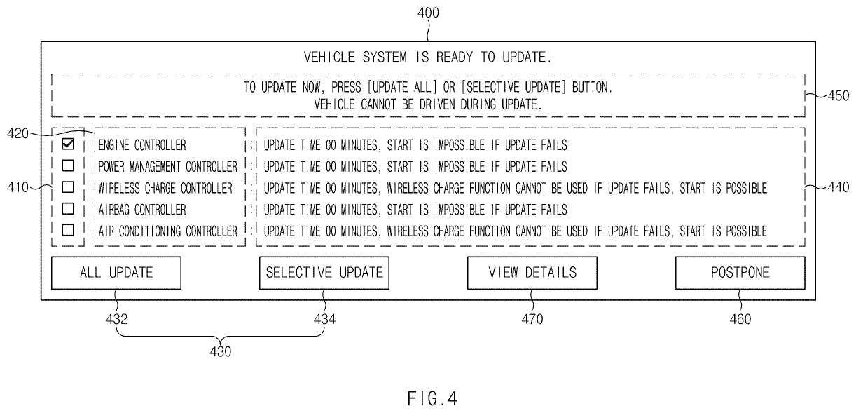

FIG. 4 is a diagram for describing an OTA update approval window of an OTA update device according to an embodiment of the present disclosure.

As shown in FIG. 4, when update target controllers are selected, the processor 120 may download software corresponding to the software releases of the selected update target controllers to memory and generate an OTA update approval window 400 that includes options for each update target controller and display the OTA update approval window 400 on the screen of a display.

The processor 120 may generate the OTA update approval window 400 that includes controller names 420 of the update target controllers, controller-specific options 410 for selecting update target controllers, and update type options 430 for determining an update execution type.

Additionally, the OTA update approval window 400 may include information 440 on update duration time for each target controller and information on unavailable vehicle functions and available vehicle functions due to update failure for each update target controller.

As illustrated in FIG. 4, the OTA update approval window 400 may include controller-specific options 410 arranged on one side of the controller names 420 of the update target controllers and update duration time information 440 arranged on the other side of the controller names 420 of the update target controllers.

Also, the OTA update approval window 400 may provide update type options including an “all update” option 432 with an execution type that updates all update target controllers, a “selective update” option 434 with an execution type that updates update target controllers based on user selection, and a “postpone” option 460 for deferring the update of the update target controllers.

In addition, the OTA update approval window 400 may further provide a detailed view option 470 for providing detailed update information.

In addition, the OTA update approval window 400 may include guidance information 450 for providing guidance on how to proceed with the update of an update target controller.

In addition, the processor 120 may determine priorities based on the update duration time information 440 for each update target controller, and sort the list of controller names 420 of the update target controllers according to the determined priorities.

For example, the processor 120 may arrange the controller names 420 of the update target controllers of which update duration times 440 are relatively short in the upper part of the list, and arrange the controller names 420 of the update target controllers of which update duration times 440 are relatively long in the lower part of the list.

In addition, the processor 120 may determine the priority based on the information on unavailable vehicle functions due to update failure, and arrange the list of controller names of the update target controllers according to the determined priority.

As an example, the processor 120 may arrange the controller names 420 in the upper part of the list when the vehicle start function is not included in the vehicle functions rendered unavailable due to an update failure, and arrange the controller names 420 in the lower part of the list when the vehicle start function is included in the vehicle functions rendered unavailable due to an update failure.

In addition, the processor 120 may determine priorities based on update duration time information 440 for each update target controller and information on vehicle functions that are unavailable due to update failure, and sort a list of controller names 420 of update target controllers according to the determined priorities.

For example, the processor 120 may arrange the controller names 420 of the update target controllers in the upper part of the list when both a first condition that the update duration time 440 is relatively short and a second condition that the vehicle start function is not included in vehicle functions rendered unavailable due to an update failure are satisfied, arrange the controller names 420 of the update target controllers in the middle part of the list when only one of the first and second conditions is satisfied, and arrange the controller names 420 of the update target controllers in the lower part of the list when both the first and second conditions are not satisfied.

In addition, when the next driving cycle for update ends, the processor 120 may generate the OTA update approval window 400 including information on controllers that have completed the update and the controllers that have not completed the update in the previous driving cycle.

In addition, the processor 120 may generate the OTA update approval window 400 including essential update information through recall and campaign and product improvement information having functional enhancement and functional addition.

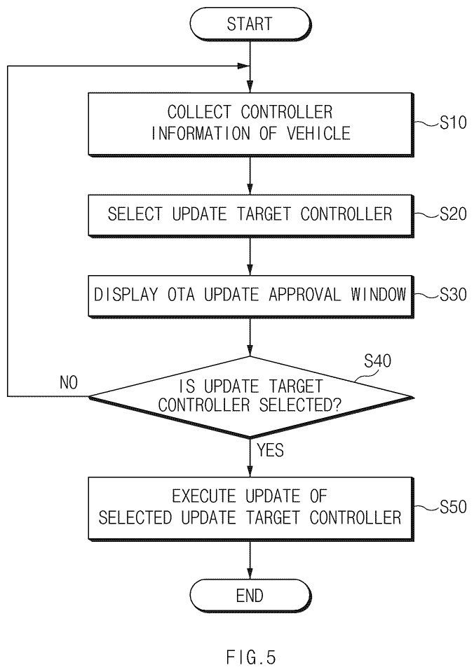

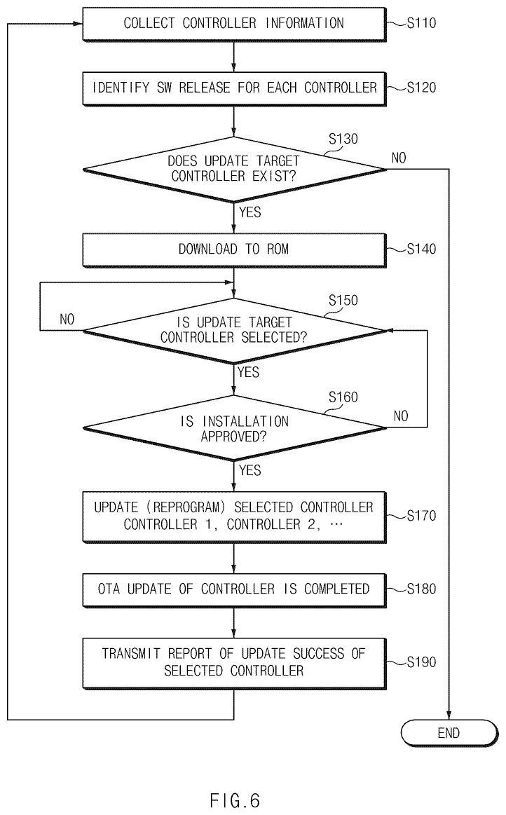

FIGS. 5 and 6 are flowcharts for describing an OTA update method of an OTA update device according to an embodiment of the present disclosure.

As shown in FIG. 5, the method according to an embodiment of the present disclosure may collect controller information of a vehicle (S10).

Then, the method according to an embodiment of the present disclosure may select an update target controller based on the controller information of the vehicle (S20).

The method according to an embodiment of the present disclosure may transmit the collected controller information to an external server to obtain controller-specific OTA event information from the external server, and select or determine an update target controller based on the obtained controller-specific OTA event information.

Next, the method according to an embodiment of the present disclosure may display an OTA update approval window in which options for each determined update target controller is provided (S30).

The method according to an embodiment of the present disclosure may download software corresponding to the software release of the determined update target controller and generate an OTA update approval window with options for each determined update target controller to display the OTA update approval window.

In an example, the OTA update approval window may include a controller name of an update target controller, controller-specific options for selecting an update target controller, and an update type options for determining an update execution type.

In addition, the OTA update approval window may include update duration time information for each update target controller, and information on unavailable vehicle functions and available vehicle functions for each update target controller due to update failure.

Then, the OTA update approval window may include update type options including an “all update” option with an execution type that updates all update target controllers, a “selective update” option with an execution type that updates target update controllers based on user selection, and a “postpone” option for deferring the update of the target update controllers.

Next, the method according to an embodiment of the present disclosure may determine whether an update target controller is selected via options on an OTA update approval window (S40).

Then, when an update target controller is selected via the options on the OTA update approval window (YES in S40), the method according to an embodiment of the present disclosure may execute an update on the selected update target controller selected via the options on the OTA update approval window (S50).

Next, the method according to an embodiment of the present disclosure may determine the update order of the selected update target controllers based on the software release serial numbers of selected update target controllers, and execute the updates of the selected update target controllers according to the determined order.

When a plurality of update target controllers has the same software release serial number, the method according to an embodiment of the present disclosure may determine the update order according to a preset priority condition.

Also, the method according to an embodiment of the present disclosure may generate an update success report for the selected update target controller and display the update success report, when the update is completed.

FIG. 6 is a flowchart for describing the OTA update method of FIG. 5 in greater detail.

As shown in FIG. 6, the method according to an embodiment of the present disclosure may collect controller information of a vehicle (S110).

Next, the method according to an embodiment of the present disclosure may identify a software release for each controller (S120).

When an OTA event for the controller of the vehicle is received, the method according to an embodiment of the present disclosure may generate an OTA event list in which software release names are matched respectively with controllers and based on the generated OTA event list, identify the software release for each controller.

Subsequently, the method according to an embodiment of the present disclosure may determine whether there is an update target controller by identifying a software release for each controller (S130).

The method according to an embodiment of the present disclosure may determine whether there is an update target controller based on the OTA event list, which includes controller names, software release names, software release serial numbers, and the like,

When there is an update target controller (YES in S130), the method according to an embodiment of the present disclosure may download a software corresponding to the software release of the update target controller to the ROM (Read Only Memory) (S140).

Furthermore, the method according to an embodiment of the present disclosure may generate and display, on the screen, an OTA update approval window that includes selection options for each update target controller and determine whether the update target controller is selected via the selection options in the OTA update approval window (S150).

The OTA update approval window may include a controller name of an update target controller, controller-specific selection options for selecting an update target controller, and an update type selection option for determining an update execution type.

The OTA update approval window may include information on update duration time required for each target controller and information on unavailable vehicle functions and available vehicle functions due to update failure for each target controller.

Next, the method according to an embodiment of the present disclosure may determine whether software installation is approved for the selected update target controller when the update target controller is selected via a selection option of the OTA update approval window (S160).

The method according to an embodiment of the present disclosure may determine whether software installation is approved for the selected update target controller based on a user input for selecting one of an “all update option” with an execution type that updates all update target controllers, a “selection update option” with an execution type that updates an update target controller based on user selection, and a “postpone option” for deferring the update of the update target controller.

Subsequently, the method according to an embodiment of the present disclosure may execute the update for the selected update target controller when the present disclosure receives a user input for selecting a selection update option, which has an execution type of updating the update target controller based on a user selection (S170).

The method according to an embodiment of the present disclosure may determine the update order of the selected update target controllers based on the software release serial numbers of selected update target controllers, and execute the update of the selected update target controllers according to the determined order.

When a plurality of update target controllers have the same software release serial number, the method according to an embodiment of the present disclosure may determine the update order according to a preset priority condition.

The method according to an embodiment of the present disclosure may then sequentially complete the update of the selected update target controllers (S180).

Next, the method according to an embodiment of the present disclosure may generate an update success report for the selected update target controller and transmit the update success report, when the update is completed (S190).

The method according to an embodiment of the present disclosure may generate an update success report for the selected update target controller and control a display to display the update success report, when the update is completed.

In some cases, the method according to an embodiment of the present disclosure may generate an update success report for the selected update target controller and transmit the update success report to an external server, when the update is completed.

In this way, an embodiment of the present disclosure may improve user convenience and safety by allowing users to individually select update target controllers through an OTA update approval window that provides options for each update target controller, and execute the update of a selected update target controller.

In addition, an embodiment of the present disclosure may improve user convenience by providing more detailed information on the updated content to a user and allowing the user to selectively apply a function capable of being updated according to the user's situation.

In addition, an embodiment of the present disclosure may reduce emergency dispatches or customer claims by allowing the user to execute the updates in a safe place.

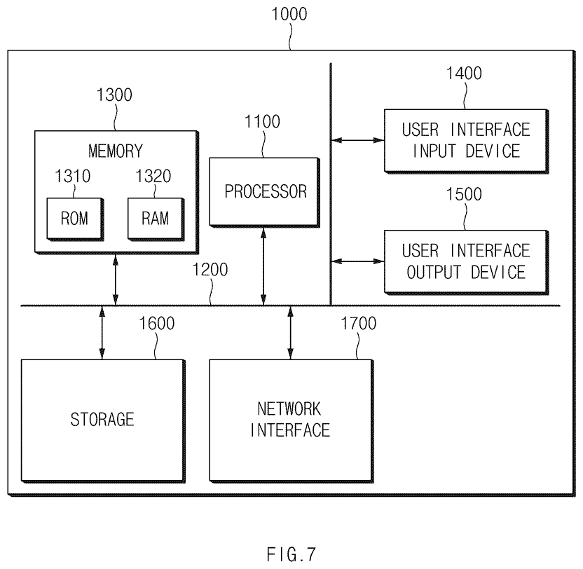

FIG. 7 illustrates a computing system for a vehicle according to an embodiment of the present disclosure.

Referring to FIG. 7, a computing system 1000 may include at least one processor 1100, a memory 1300, a user interface input device 1400, a user interface output device 1500, storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a Read Only Memory (ROM) and a Random Access Memory (RAM).

Thus, the operations of the method or the algorithm described in connection with the embodiments disclosed herein may be embodied directly in hardware or a software module executed by the processor 1100, or in a combination thereof. The software module may reside on a storage medium (i.e., the memory 1300 and/or the storage 1600) such as a RAM, a flash memory, a ROM, an EPROM (erasable programmable read-only memory), an EEPROM (electrically erasable programmable read-only memory), a register, a hard disk, a removable disk, and a CD compact disk)-ROM.

The storage medium may be coupled to the processor 1100, and the processor 1100 may read information out of the storage medium and may record information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

The above description is merely illustrative of the technical idea of the present disclosure, and various modifications and variations may be made without departing from the essential characteristics of the present disclosure by those having ordinary skill in the art to which the present disclosure pertains.

Accordingly, the embodiments disclosed in the present disclosure are not intended to limit the technical idea of the present disclosure but to describe the present disclosure, and the scope of the technical idea of the present disclosure is not limited by the embodiments. The scope of protection of the present disclosure should be interpreted by the following claims, and all technical ideas within the scope equivalents thereto should be construed as being included in the scope of the present disclosure.

An embodiment of the present disclosure may improve user convenience and safety by allowing users to individually select update target controllers through an OTA update approval window that provides options for each update target controller, and execute the update of a selected update target controller.

In addition, an embodiment of the present disclosure may improve user convenience by providing more detailed information on the updated content to a user and allowing the user to selectively apply a function capable of being updated according to the user's situation.

In addition, an embodiment of the present disclosure may reduce emergency dispatches or customer claims by allowing the user to execute the update in a safe place.

In addition, various effects may be provided that are directly or indirectly understood through the disclosure.

Hereinabove, although the present disclosure has been described with reference to embodiments and the accompanying drawings, the present disclosure is not limited thereto, but may be variously modified and altered by those having ordinary skill in the art to which the present disclosure pertains without departing from the spirit and scope of the present disclosure claimed in the following claims.

What is claimed is:

1. An over-the-air (OTA) update device comprising:
a display configured to display an OTA update approval window; and
a processor configured to control the display,
wherein the processor is further configured to
determine update target controllers based on controller information of a vehicle,
control the display to display the OTA update approval window in which options for the determined update target controllers are provided, and,
execute, based on the determined update target controllers being selected via the options of the OTA update approval window, updates for the selected update target controllers.

2. The OTA update device of claim 1, wherein, in determining the update target controllers, the processor is further configured to:
collect the controller information of the vehicle;
transmit the collected controller information to an external server to obtain controller-specific OTA event information from the external server; and
determine the update target controllers based on the obtained controller-specific OTA event information.

3. The OTA update device of claim 2, wherein the controller-specific OTA event information includes an OTA event list in which software release names are matched respectively with controllers.

4. The OTA update device of claim 1, wherein, in controlling the display, the processor is further configured to:
download, based on the update target controllers being determined, software corresponding to software releases of the determined update target controllers to a memory; and
control the display to generate the OTA update approval window that includes options for the determined update target controllers and display the OTA update approval window.

5. The OTA update device of claim 4, wherein, in generating the OTA update approval window, the processor is further configured to generate the OTA update approval window including controller names of the determined update target controllers, controller-specific options for selecting an update target controller, and an update type option for determining an update execution type.

6. The OTA update device of claim 5, wherein, in generating the OTA update approval window, the processor is further configured to generate the OTA update approval window including information on update duration time for the determined update target controllers and information on unavailable vehicle functions due to update failure and available vehicle functions for the determined update target controllers.

7. The OTA update device of claim 5, wherein, in generating the OTA update approval window, the processor is further configured to provide
update type options including
an all update option with an execution type that updates all determined update target controllers,
a selective update option with an execution type that updates the determined update target controllers based on user selection, and
a postpone option for deferring update of the determined update target controllers.

8. The OTA update device of claim 1, wherein, in executing the updates, the processor is further configured to:
determine an update order of the selected update target controllers based on software release serial numbers of the selected update target controllers; and
execute the updates of the selected update target controllers based on the determined update order.

9. The OTA update device of claim 8, wherein, in determining the update order, the processor is further configured to determine, based on a predetermined priority condition, the update order based on a plurality of update target controllers having a same software release serial number.

10. The OTA update device of claim 1, wherein the processor is further configured to:
generate an update success report for the selected update target controllers based on the updates being completed; and
control the display to display the update success report.

11. An over-the-air (OTA) update method of an OTA update device for a vehicle, the OTA update method comprising:
collecting controller information of the vehicle;
determining update target controllers based on the controller information of the vehicle;
displaying an OTA update approval window in which options for the determined update target controllers are provided;
determining whether the determined update target controllers are selected via options of the OTA update approval window; and
executing, based on the determined update target controllers being selected, updates for the selected update target controllers.

12. The OTA update method of claim 11, wherein determining the update target controllers includes:
transmitting the collected controller information to an external server to obtain controller-specific OTA event information from the external server; and
determining the update target controllers based on the obtained controller-specific OTA event information.

13. The OTA update method of claim 12, wherein the controller-specific OTA event information includes an OTA event list in which software release names are matched respectively with controllers.

14. The OTA update method of claim 11, wherein displaying the OTA update approval window includes:
downloading software corresponding to software releases of the determined update target controllers; and
generating the OTA update approval window that includes options for the determined update target controllers to display the OTA update approval window.

15. The OTA update method of claim 14, wherein generating the OTA update approval window includes generating the OTA update approval window including controller names of the determined update target controllers, controller-specific options for selecting an update target controller, and an update type option for determining an update execution type.

16. The OTA update method of claim 15, wherein generating the OTA update approval window includes generating the OTA update approval window including information on update duration time for the determined update target controllers and information on unavailable vehicle functions due to update failure and available vehicle functions for the determined update target controllers.

17. The OTA update method of claim 15, wherein generating the OTA update approval window includes providing update type options including:
an all update option with an execution type that updates all determined update target controllers;
a selective update option with an execution type that updates the determined update target controllers based on user selection; and
a postpone option for deferring update of the determined update target controllers.

18. The OTA update method of claim 11, wherein executing the updates includes:
determining an update order of the selected update target controllers based on software release serial numbers of the selected update target controllers; and
executing the updates of the selected update target controllers based on the determined update order.

19. The OTA update method of claim 18, wherein determining the update order includes determining, based on a predetermined priority condition, the update order based on a plurality of update target controllers having a same software release serial number.

20. The OTA update method of claim 11, wherein executing the updates includes:
generating an update success report for the selected update target controllers based on the updates being completed; and
displaying the update success report.
